(19) United States
(12) Patent Application Publication
(10) Pub. No.: US 2026/0214609 A1
(43) Pub. Date: Jul. 23, 2026

(54) BASE STATION DEVICE, COMMUNICATION METHOD, AND COMPUTER-READABLE MEDIUM

(71) Applicant: NEC Corporation, Tokyo (JP)

(72) Inventors: Daichi SHIRASE, Tokyo (JP); Kazushi Muraoka, Tokyo (JP); Toshiki Takeuchi, Tokyo (JP)

(73) Assignee: NEC Corporation, Tokyo (JP)

(21) Appl. No.: 19/443,096

(22) Filed: Jan. 8, 2026

(30) Foreign Application Priority Data
Jan. 22, 2025 (JP) 2025-009029

(51) Int. Cl. H04W 56/00; H04W 88/08

(52) U.S. Cl. CPC H04W 56/005; H04W 56/0065; H04W 88/08

(57) ABSTRACT

To more appropriately pre-compensate for at least one of a propagation delay and a Doppler shift accompanying movement of a wireless terminal. There is provided a base station device including an acquisition unit for acquiring information indicating a characteristic related to at least one of a propagation delay and a Doppler shift in each wireless terminal, and a correction unit for correcting a phase of a signal to be transmitted to each wireless terminal in a frequency domain based on the characteristic in each wireless terminal.

### INCORPORATION BY REFERENCE

This application is based upon and claims the benefit of priority from Japanese patent application No. 2025-009029, filed on Jan. 22, 2025, the disclosure of which is incorporated herein in its entirety by reference.

### TECHNICAL FIELD

The present disclosure relates to a base station device, a communication method, and a program.

### BACKGROUND ART

WO 2022/269874 A1 describes that a base station performs a Doppler pre (preliminary) compensation (correction) scheme in transmission of a downlink (DL) signal/channel to a UE in an HST from a TRP.

### SUMMARY

However, in the technology described in WO 2022/269874 A1, for example, there is room for improvement in pre-compensation of at least one of a propagation delay and a Doppler shift accompanying movement of a wireless terminal.

In view of the above-described problems, an example object of the present disclosure is to provide a technology capable of more appropriately pre-compensating at least one of a propagation delay and a Doppler shift accompanying movement of a wireless terminal.

According to a first example aspect of the present disclosure, there is provided a base station device including an acquisition unit for acquiring information indicating a characteristic related to at least one of a propagation delay and a Doppler shift in each wireless terminal, and a correction unit for correcting a phase of a signal to be transmitted to each wireless terminal in a frequency domain based on the characteristic in each wireless terminal.

According to a second example aspect of the present disclosure, there is provided a communication method including acquiring information indicating a characteristic related to at least one of a propagation delay and a Doppler shift in each wireless terminal, and correcting a phase of a signal to be transmitted to each wireless terminal in a frequency domain based on the characteristic in each wireless terminal.

According to a third example aspect of the present disclosure, there is provided a program for causing a computer to execute processing of acquiring information indicating a characteristic related to at least one of a propagation delay and a Doppler shift in each wireless terminal, and correcting a phase of a signal to be transmitted to each wireless terminal in a frequency domain based on the characteristic in each wireless terminal.

According to one aspect, at least one of a propagation delay and a Doppler shift accompanying movement of a wireless terminal can be more appropriately pre-compensated.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a configuration of a base station device according to an example embodiment;

FIG. 2 is a diagram illustrating a configuration example of a communication system according to the example embodiment;

FIG. 3 is a diagram illustrating a hardware configuration example of the base station device according to the example embodiment;

FIG. 4 is a flowchart illustrating an example of processing of the base station device according to the example embodiment; and

FIG. 5 is a diagram illustrating an example of processing of the base station device according to the example embodiment.

### EXAMPLE EMBODIMENTS

The principles of the present disclosure will be described with reference to several exemplary example embodiments. It is to be understood that the example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings. Each of the drawings is merely an example to illustrate one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any of the drawings may be changed as appropriate.

### First Example Embodiment

### <Configuration>

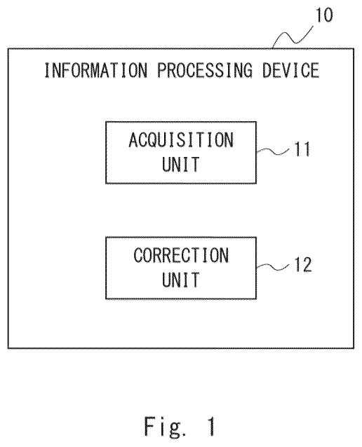

A configuration of a base station device 10 according to an example embodiment will be described with reference to FIG. 1. FIG. 1 is a diagram illustrating an example of a configuration of the base station device 10 according to the example embodiment. The base station device 10 includes an acquisition unit 11 and a correction unit 12. These units may be implemented by cooperation of one or more programs installed in the base station device 10 and hardware such as a processor and a memory of the base station device 10.

The acquisition unit 11 acquires information indicating a characteristic related to at least one of a propagation delay and a Doppler shift of a signal received from the base station device 10 in each of a plurality of wireless terminals. The correction unit 12 corrects the phase of the signal to be transmitted to each wireless terminal in the frequency domain based on the characteristic in each wireless terminal. As a result, for example, at least one of the propagation delay and the Doppler shift accompanying the movement of the wireless terminal can be more appropriately pre-compensated. Therefore, for example, it is possible to appropriately communicate with the wireless terminal moving at a high speed simultaneously with a plurality of base stations or while switching a plurality of base stations.

The correction unit 12 of the present disclosure is not limited to, for example, an example of correcting a signal in a frequency domain before modulation. Examples of wireless communication systems in which a signal before modulation is a signal in a frequency domain include Orthogonal Frequency Division Multiple Access (OFDMA) and Single Carrier Frequency Division Multiple Access (SC-FDMA).

In a case where the wireless communication system is Code Division Multiple Access (CDMA), the correction unit 12 may correct the signal of the code area. Furthermore, in a case where the wireless communication system is an Orthogonal Time Frequency Space (OTFS), the correction unit 12 may correct the signal in the delay-Doppler region.

### Second Example Embodiment

### <System Configuration>

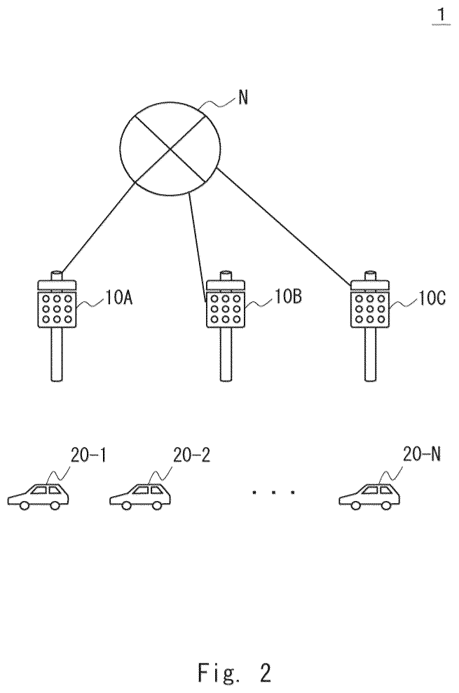

Next, a configuration of a communication system 1 according to the example embodiment will be described with reference to FIG. 2. FIG. 2 is a diagram illustrating a configuration example of a communication system 1 according to the example embodiment. In the example of FIG. 2, the communication system 1 includes a base station device 10A, a base station device 10B, and a base station device 10C. Hereinafter, in a case where it is not necessary to distinguish each of the base station devices 10A to 10C, the base station devices are also simply referred to as “base station devices 10”. In addition, the communication system 1 includes a wireless terminal 20-1, a wireless terminal 20-2, . . . , and a wireless terminal 20-N (N is an integer equal to or greater than two). Hereinafter, in a case where it is not necessary to distinguish the wireless terminals 20-1 to 20-N, they are also simply referred to as “wireless terminals 20”. The numbers of the base station devices 10 and the wireless terminals 20 are not limited to the example of FIG. 2.

In the example of FIG. 2, each base station device 10 is connected in such a way as to be able to communicate via a network N. Examples of the network N include, for example, a core network, the Internet, a Local Area Network (LAN), a bus, and the like. In addition, they are connected in such a way as to be able to communicate by wireless communication of a mobile communication system (e.g., Radio Access Technology (RAT)). Examples of the mobile communication system include, for example, a fifth generation mobile communication system (5G), a sixth generation mobile communication system (6G, Beyond 5G), a fourth generation mobile communication system (4G), and a third generation mobile communication system (3G).

The base station device 10 transmits and receives radio waves and relays communication between the wireless terminal 20 and the network N. The base station device 10 may be a virtualized base station (virtual RAN (vRAN)) in which the physical functions of the base station are separated by software.

The wireless terminal 20 may be, for example, an in-vehicle communication device mounted on a vehicle or the like, or a mobile terminal such as a smartphone possessed by a user in the vehicle. Furthermore, the wireless terminal 20 may be, for example, a repeater (e.g., Integrated Access Backhaul (IAB) and Wireless Access Backhaul (WAB)) or the like that relays communication to a mobile terminal possessed by a user in the vehicle.

### <Hardware Configuration>

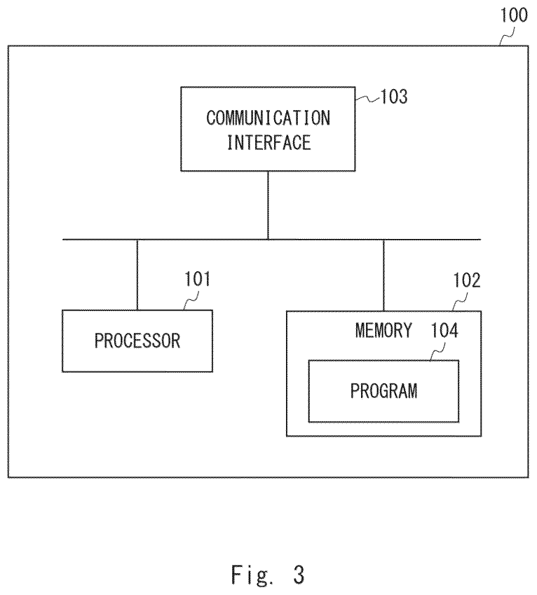

FIG. 3 is a diagram illustrating a hardware configuration example of the base station device 10 according to the example embodiment. In the example of FIG. 3, the base station device 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

In a case where the program 104 is executed by the cooperation of the processor 101, the memory 102, and the like, at least a part of processing according to the example embodiment of the present disclosure is performed by the computer 100. The memory 102 may be of any type. The memory 102 may be a non-transitory computer-readable storage medium, as a non-limiting example. The memory 102 may also be implemented using any appropriate data storage technique such as a semiconductor-based memory device, a magnetic memory device and system, an optical memory device and system, a fixed memory, and a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a Digital Signal Processor (DSP), and a processor based on a multi-core processor architecture as a non-limiting example. The computer 100 may include a plurality of processors such as application specific integrated circuit chips that are temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as instructions included in a program module, and is executed on a device on a target real or virtual processor to execute the processes or methods of the present disclosure. The program module includes routines, programs, libraries, objects, classes, components, data structures, and the like that execute specific tasks or implement specific abstract data types. Functions of the program module may be combined or divided between the program modules as desired in various example embodiments. A machine-executable instruction of the program module can be executed in a local or distributed device. In the distributed device, the program modules can be located on both local and remote storage media.

Program codes for executing the methods of the present disclosure may be written in any combination of one or more programming languages. These program codes are provided to a processor or controller of a general purpose computer, a dedicated computer, or other programmable data processing devices. In a case where the program codes are executed by the processor or controller, the functions/operations in the flowcharts and/or the implemented block diagrams are executed. The program code is executed entirely on a machine, partially on the machine as a stand-alone software package, partially on the machine and partially on a remote machine, or entirely on the remote machine or server.

The program includes instructions (or software codes) for causing the computer to perform one or more functions described in the example embodiment in a case of being read by the computer. The programs may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. By way of example, and not limitation, transitory computer-readable or communication media include electrical, optical, acoustic, or other forms of propagation signals.

### <Processing>

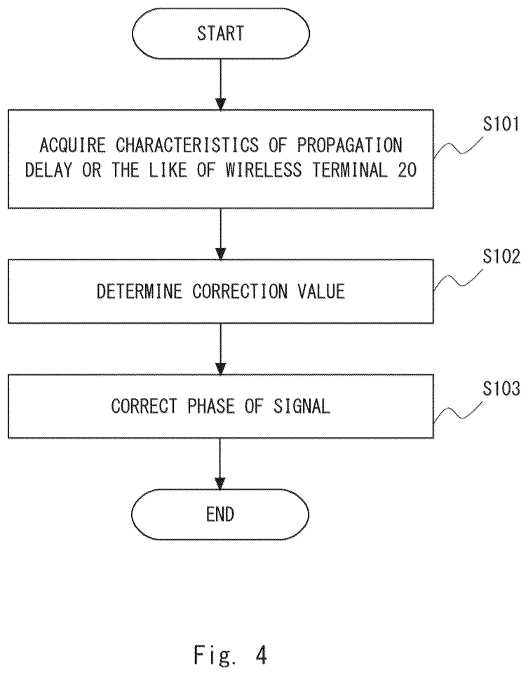

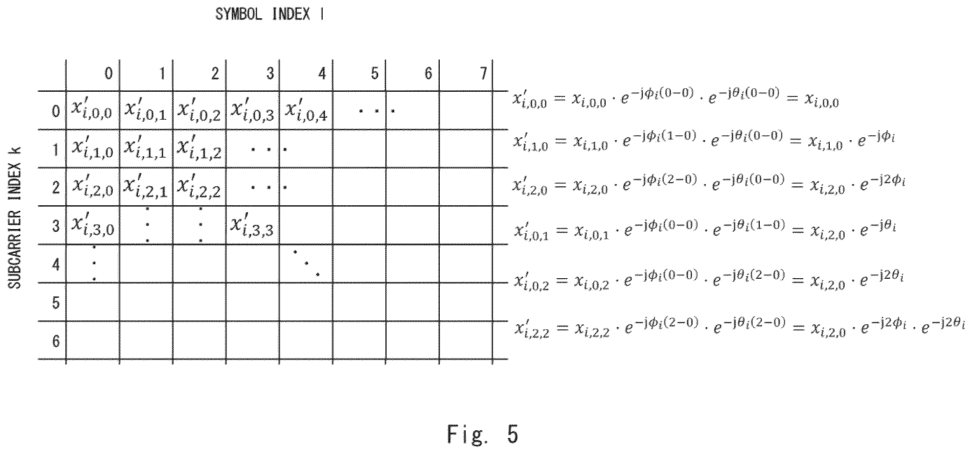

Next, an example of processing of the base station device 10 according to the example embodiment will be described with reference to FIGS. 4 and 5. FIG. 4 is a flowchart illustrating an example of processing of the base station device 10 according to the example embodiment. FIG. 5 is a diagram illustrating an example of processing of the base station device 10 according to the example embodiment. The processing of FIG. 4 may be executed, for example, at regular timing or the like.

In step S101, the acquisition unit 11 acquires information indicating characteristics related to at least one of the propagation delay and the Doppler shift of the radio wave received by each wireless terminal 20 from each base station device 10. Here, for example, the acquisition unit 11 may acquire (measure, infer) values (characteristic values) of the propagation delay and the Doppler shift with respect to the base station device 10 based on channel measurement information for each of one or more base station devices 10 (e.g., the base station device 10A, the base station device 10B, etc.) sent from the wireless terminal 20. In this case, the characteristic value of each wireless terminal 20 may be calculated by the base station device 10 or the wireless terminal 20 based on, for example, the pilot signal transmitted from the base station device 10 and received by the wireless terminal 20. The pilot signal may be, for example, a signal known by the base station device 10 and the wireless terminal 20.

Subsequently, the correction unit 12 corrects the phase of the signal to be transmitted to each wireless terminal 20 in the frequency domain based on the characteristic in each wireless terminal 20 (step S102). Here, the correction unit 12 may correct the phase or the like according to the correction value (offset, pre-compensation amount) for each wireless terminal 20 with respect to the frequency domain signal before the secondary modulation for each wireless terminal 20.

The correction unit 12 may perform phase correction on the transmission signals (complex symbols) x′_{i, l, l} mapped to the subcarrier index k and the symbol index l to be transmitted to the wireless terminal 20-i (i is an integer equal to or greater than two) as in the following formula (1).

$$\begin{matrix}[ Mathematical formula 1 ] & \\ {x}_{i , k , l}^{′} = {x}_{i , k , l} \cdot {e}^{- j {ϕ}_{i} ( k - {k}_{0} )} \cdot {e}^{- j {ϕ}_{i} ( l - {l}_{0} )} & ( 1 )\end{matrix}$$

Here, x_{i, l, l} is a transmission signal (complex symbol) before phase correction to be mapped to the subcarrier index k and the symbol index l of the wireless terminal 20-i. l₀ is a symbol index of any reference resource element (RE). k₀ is a subcarrier index of any reference RE.

θᵢ=2πΔfᵢTₛ is the phase rotation correction amount of the signal mapped to the RE shifted by one symbol from the symbol index of the reference RE at the time of frequency correction. Φᵢ=2πf₀Δtᵢ is the phase rotation correction amount of the signal mapped to the RE shifted by one subcarrier from the subcarrier index of the reference RE at the time of timing correction. Δfᵢ is a frequency offset [Hz] to be compensated for the wireless terminal 20-i. Δtᵢ is a timing offset [sec] to be compensated for the wireless terminal 20-i. Tₛ is a symbol interval [sec]. f₀ is a subcarrier interval [Hz]. In Formula (1), exp{−jΦᵢ(k−k₀)} is a term for correcting the transmission timing, and exp{−jθᵢ(l−l₀)} is a term for correcting the transmission frequency.

The subcarrier index k₀ and the symbol index l₀ to be the reference may be arbitrary. For example, the correction unit 12 may set (k₀, l₀)=(0, 0). In addition, the correction unit 12 may set each index serving as a reference to be common to a plurality of wireless terminals 20, or may set each index for each wireless terminal 20. FIG. 5 illustrates an example of phase correction in a case where the reference resource element is set to the subcarrier index 10=0 and the symbol index k₀=0.

Hereinafter, the influence of the frequency offset caused by the Doppler shift and the like on demodulation after reception in the OFDM system will be described. However, for the sake of simplicity, the index of the wireless terminal 20 is omitted. x_{k, l} represents a transmission symbol mapped to the subcarrier index k and the symbol index l. In addition, the subcarrier interval is f₀, and the number of subcarriers is K.

Attention is given to the symbol index l. First, the frequency domain signal x_{k,l}(k=0, . . . , K−1) is OFDM-modulated by a K-point Inverse Fast Fourier Transform (IFFT) and converted into a time domain sample sₗ[n] (k=0, . . . , K−1) by the following Formula (2).

$$\begin{matrix}[ Mathematical formula 2 ] & \\ {S}_{l} [ n ] = \frac{1}{\sqrt{K}} {\sum }_{k = 0}^{K - 1} {x}_{k , l} {e}^{j 2 π k \frac{n}{N}} & ( 2 )\end{matrix}$$

Then, the time domain continuous signal sₗ(t) is generated by the following Formula (3) based on each sample point.

$$\begin{matrix}[ Mathematical formula 3 ] & \\ {S}_{l} ( t ) = \frac{1}{\sqrt{K}} {\sum }_{k = 0}^{K - 1} {x}_{k , l} {e}^{j 2 π k {f}_{0} t} & ( 3 )\end{matrix}$$

Next, assuming that a frequency offset of Δf [Hz] occurs due to a Doppler shift or the like in the receiver (wireless terminal 20), each of the reception time domain continuous signal sₗ^{RX}(t) and the sampled reception time domain sample sₗ^{RX}[n] is expressed by the following Formulas (4) and (5). However, the channel fluctuation caused by a phenomenon different from the frequency offset is omitted.

$$\begin{matrix}[ Mathematical formula 4 ] & \\ {s}_{l}^{R X} ( t ) = \frac{1}{\sqrt{K}} {\sum }_{k = 0}^{K - 1} {x}_{k , l} {e}^{j 2 π ( k {f}_{0} + Δ f ) t} & ( 4 )\end{matrix}$$

$$\begin{matrix}[ Mathematical formula 5 ] & \\ {s}_{l}^{R X} [ n ] = \frac{1}{\sqrt{K}} {\sum }_{k = 0}^{K - 1} {x}_{k , l} {e}^{j 2 π k \frac{n}{N}} \cdot {e}^{j 2 π \frac{Δ f}{{Kf}_{0}} n} = {s}_{l} [ n ] \cdot {e}^{j {θ}^{′} n} & ( 5 )\end{matrix}$$

$$∵ {θ}^{′} = 2 π \frac{Δ f}{{Kf}_{0}}$$

Next, OFDM demodulation by K-point Fast Fourier transform (FFT) is performed on the reception time domain sample sₗ^{RX}[n]. The demodulated reception frequency domain signal x_{k, l}^{RX} is expressed by the following Formula (6)

$$\begin{matrix}[ Mathematical formula 6 ] & \\ {x}_{k , l}^{RX} = \frac{1}{\sqrt{K}} {\sum }_{n = 0}^{K - 1} {s}_{l}^{RX} [ N ] {e}^{- j 2 π k \frac{n}{N}} = \frac{1}{\sqrt{K}} {\sum }_{n = 0}^{K - 1} {s}_{l} [ n ] \cdot {e}^{j {θ}^{′} n} {e}^{- j 2 π k \frac{n}{N}} = \frac{1}{K} {\sum }_{n = 0}^{K - 1} {e}^{j {θ}^{′} n} {x}_{k , l} + {σ}_{ICI} = {h}_{k , l} {x}_{l , l} + {σ}_{ICI} & ( 6 )\end{matrix}$$

$$∵ {h}_{k , l} = \frac{1}{K} {\sum }_{n = 0}^{K - 1} {e}^{j {θ}^{′} n}$$

As described above, the orthogonality of OFDM is lost due to the influence of the frequency offset Δf, and after the reception, the demodulated x_{k, l}^{RX} is obtained by adding the attenuation of h_{k, l} and the inter-subcarrier interference σ_{ICI} with respect to the actual transmission signal x_{k, l} and demodulating.

The reception frequency domain signal x_{k, l+l′}^{RX} in a case where x_{k, l+l′} transmitted after l′ symbols of x_{k, l} is subjected to the frequency offset Δf, is expressed by the following Formula (7) in a case of being similarly calculated.

$$\begin{matrix}[ Mathematical formula 7 ] & \\ {x}_{k , l + {l}^{′}}^{RX} = {e}^{j θ {l}^{′}} \cdot \frac{1}{K} {\sum }_{n = 0}^{K - 1} {e}^{j {θ}^{′} n} {x}_{k , l + {l}^{′}} + {σ}_{ICI} = {e}^{j θ {l}^{′}} \cdot {h}_{k , l} {x}_{k , l + {l}^{′}} + {σ}_{ICI} = {h}_{k , l + {l}^{′}} {x}_{k , l + {l}^{′}} + {σ}_{ICI} & ( 7 )\end{matrix}$$

$$∵ θ = 2 πΔ f {T}_{s}$$

From the above, since h_{k, l+l}=h_{k, l}e^{jθl′} holds, it can be confirmed that the phase of the channel of the frequency domain rotates with elapse of time by the frequency offset. In OFDM, a channel is estimated by mapping a known pilot symbol between a transmitter and a receiver to a specific Resource Element (RE). Here, pilot symbols are often mapped sparsely to some extent from the viewpoint of resource utilization efficiency, and the channels of the REs to which the pilot symbols are not mapped are estimated and interpolated based on channel estimation values of the REs in which surrounding pilot symbols are arranged. Therefore, in a case where the time variation of the channel due to the frequency offset cannot be accurately grasped, a large error occurs between the actual channel and the channel estimation value, and demodulation performance is significantly degraded.

As described above, the orthogonality of OFDM is lost because the phase rotation of e^{jθ′n} occurs in each reception time domain sample sₗ^{Rx}[n] with respect to each transmission time domain sample sₗ[n] due to the frequency offset. Therefore, it is possible to compensate for the influence of the frequency offset and also compensate for the attenuation and the inter-subcarrier interference as in Formula (8) by transmitting s′ₗ[n]=sₗ[n]e^{-jθ′n} obtained by applying the reverse rotation of the assumed phase rotation with respect to the time domain sample at the time of transmission.

$$\begin{matrix}[ Mathematical formula 8 ] & \\ {x}_{k , l}^{RX} = \frac{1}{\sqrt{K}} {\sum }_{n = 0}^{K - 1} {s}_{l}^{RX} [ n ] {e}^{- j 2 π k \frac{n}{N}} = \frac{1}{\sqrt{K}} {\sum }_{n = 0}^{K - 1} {s}_{l}^{′} [ n ] \cdot {e}^{\text{?}} {e}^{- j 2 π k \frac{n}{N}} = \frac{1}{\sqrt{K}} {\sum }_{n = 0}^{K - 1} {s}_{l} [ n ] {e}^{\text{?}} \cdot {e}^{\text{?}} {e}^{- j 2 π k \frac{n}{N}} = \frac{1}{\sqrt{K}} {\sum }_{n = 0}^{K - 1} {s}_{l} [ n ] {e}^{- j 2 π k \frac{n}{N}} = {x}_{k , l} & ( 8 )\end{matrix}$$

$$\text{?} \text{indicates text missing or illegible when filed}$$

The time-domain pre-compensation of the frequency offset applies correction according to the assumed frequency offset with respect to the transmission time-domain sample sₗ[n]. In a case of frequency/spatial multiplexing of signals of a plurality of wireless terminals, since the transmission time domain sample is generated by combining signals of the plurality of wireless terminals to be multiplexed, it is very difficult to apply different corrections for each wireless terminal.

As shown in Formula (7), it is also a problem that the phase of the channel in the frequency domain rotates with the elapse of time due to the frequency offset. Therefore, by transmitting x′_{k,l+l}^{RX}=x_{k,l+l′}e^{-jθl′} obtained by applying the reverse rotation of the assumed phase rotation to the frequency domain symbol at the time of transmission, it is possible to compensate for the rotation accompanying the elapse of time of the phase of the channel of the frequency domain due to the frequency offset as in the following Formula (9).

$$\begin{matrix}[ Mathematical formula 9 ] & \\ {x}_{k + {l}^{′} , l}^{RX} = {e}^{j θ {l}^{′}} \cdot {h}_{k , l} {x}_{k , l + {l}^{′}}^{′} + {σ}_{ISI} = {e}^{j θ {l}^{′}} \cdot {h}_{k , l} {e}^{- j θ {l}^{′}} {x}_{k , l + {l}^{′}} + {σ}_{ISI} = {h}_{k , l} {x}_{k , l + {l}^{′}} + {σ}_{ISI} & ( 9 )\end{matrix}$$

In this way, the frequency domain pre-compensation can compensate for the phase rotation of the frequency domain channel due to the frequency offset, but cannot resolve the attenuation of h_{k, l} due to the frequency offset and the inter-subcarrier interference σ_{ICI}. On the other hand, the frequency domain pre-compensation can apply different corrections to the transmission symbol of each wireless terminal in the frequency domain.

Similarly to the case of the frequency offset, the phase of the frequency domain channel rotates as the following Formula (10) with the frequency offset of each channel with respect to the reference frequency (assumed as subcarrier k) due to the timing offset (offset of the reception timing) At generated by the propagation delay.

$$\begin{matrix}[ Mathematical formula 10 ] & \\ {x}_{k + {k}^{′} , l}^{RX} = {e}^{j ϕ {k}^{′}} \cdot {h}_{k , l} {x}_{k + {k}^{′} , l}^{′} + {σ}_{ISI} , & ( 10 )\end{matrix}$$

$$∵ ϕ = 2 π {f}_{0} Δ t$$

Therefore, by transmitting x′_{k+k′, l}=x_{k+k′, l}e^{-jθk′} obtained by applying the reverse rotation of the assumed phase rotation to the frequency domain symbol at the time of transmission, it is possible to compensate for rotation accompanying the frequency offset of the phase of the frequency domain channel by the timing offset as in the following Formula (11).

$$\begin{matrix}[ Mathematical formula 11 ] & \\ {x}_{k + {k}^{′} , l}^{RX} = {e}^{j ϕ {k}^{′}} \cdot {h}_{k , l} {x}_{k + {k}^{′} , l}^{′} + {σ}_{ISI} = {e}^{j ϕ {k}^{′}} \cdot {h}_{k , l} {e}^{- j ϕ {k}^{′}} {x}_{k + {k}^{′} , l} + {σ}_{ISI} & ( 11 )\end{matrix}$$

In the 5G OFDM system, a cyclic prefix (CP) is given to each time domain OFDM symbol in order to deal with a timing offset caused by a propagation delay or the like. The attenuation of h_{k, l} and the inter-symbol interference σ_{ICI} described above occur in a case where the timing offset exceeds the CP length, and cannot be compensated by the frequency domain pre-compensation. On the other hand, the frequency domain pre-compensation can apply different corrections to the transmission symbol of each wireless terminal in the frequency domain.

### <<Regarding Processing of Determining Correction Value>>

The correction unit 12 may measure at least one of the frequency offset caused by the Doppler shift and the timing offset caused by the propagation delay or the like, and determine the value of the measured offset as the correction value.

As an example, a method of measuring each offset of the wireless terminal 20-i (i is an integer equal to or greater than two) using the pilot signal in a case where the secondary modulation is Orthogonal Frequency-Division Multiplexing (OFDM) will be described.

### (Calculation Example of Frequency Offset)

The correction unit 12 may calculate the phase rotation θ_{i, l, l}^{means} among the plurality of pilot signals by the following Formula (12). Here, arg(z) is the argument of the complex number of z.

$$\begin{matrix}[ Mathematical formula 12 ] & \\ {θ}_{i , l , {l}^{′}}^{meas} = arg ( {h}_{i , l + {l}^{′} , k} ) - arg ( {h}_{i , l , k} ) & ( 12 )\end{matrix}$$

Then, the correction unit 12 may perform conversion into the phase rotation θᵢ^{means} between one symbol by the following Formula (13).

$$\begin{matrix}[ Mathematical formula 13 ] & \\ {θ}_{i}^{meas} = \frac{{θ}_{i , l , {l}^{′}}^{meas}}{{l}^{′} {T}_{s}} & ( 13 )\end{matrix}$$

Then, the correction unit 12 may perform conversion into the frequency offset Δfᵢ by the following Formula (14).

$$\begin{matrix}[ Mathematical formula 14 ] & \\ Δ {f}_{i} = {θ}_{i}^{m e a s} / 2 π & ( 14 )\end{matrix}$$

### (Calculation Example of Timing Offset)

The correction unit 12 may calculate the phase rotation φ_{i, k, k′}^{means} among the plurality of pilot signals by the following Formula (15).

$$\begin{matrix}[ Mathematical formula 15 ] & \\ {ϕ}_{i , k , {k}^{′}}^{m e a s} = arg ( {h}_{i , l , k + {k}^{′}} ) - arg ( {h}_{i , l , k} ) & ( 15 )\end{matrix}$$

Then, the correction unit 12 may perform conversion into the phase rotation φᵢ^{means} between one sub-carrier by the following Formula (16).

$$\begin{matrix}[ Mathematical formula 16 ] & \\ {ϕ}_{i}^{meas} = \frac{{ϕ}_{i , k , {k}^{′}}^{meas}}{{k}^{′} {f}_{0}} & ( 16 )\end{matrix}$$

Then, the correction unit 12 may perform conversion into the timing offset Δtᵢ by the following Formula (17).

$$\begin{matrix}[ Mathematical formula 17 ] & \\ Δ {t}_{i} = {ϕ}_{i}^{m e a s} / 2 π & ( 17 )\end{matrix}$$

The above is an example, and the frequency offset and the timing offset may be measured by other methods. In this case, for example, the correction unit 12 may determine each offset by not only the phase rotation between the two channels but also the average of the phase rotations among the plurality of measurement channels.

The correction unit 12 may multiply a signal to be mapped by a multi-antenna weight for an arbitrary RE as necessary. In a case where a plurality of frequency domain signals are mapped to the RE, the correction unit 12 may weight combine the plurality of frequency domain signals to be mapped according to the precoding weight and generate a signal to be mapped to the RE. In a case where U frequency domain signals are mapped to RE(k, l), the correction unit 12 may calculate the precoded frequency domain signal xk, l as in the following Formula (18). Here, wᵢ is a multi-antenna weight for the i^{th} frequency domain signal.

$$\begin{matrix}[ Mathematical formula 18 ] & \\ {x}_{k , l} = {\sum }_{i = 0}^{U - 1} {w}_{i} {x}_{i , k , l}^{′} & ( 18 )\end{matrix}$$

### (Example of Correction Also in Time Domain)

The correction unit 12 may correct the phase of the signal to be transmitted to each wireless terminal in the frequency domain and the time domain based on the characteristics in each wireless terminal 20. Thus, for example, at least one of the frequency offset and the timing offset for each wireless terminal that cannot be compensated by the time domain pre-compensation common among the wireless terminals 20, can be compensated for by the frequency domain pre-compensation. More specifically, for example, the influence of the frequency offset and the timing offset for each wireless terminal 20 that cannot be compensated with the time domain correction can be compensated by the frequency domain pre-compensation while reducing the influence of the loss of orthogonality of the secondary modulation by the time domain correction.

The correction unit 12 may correct the time domain signal based on a correction value of at least one of a frequency offset and a timing offset for time domain correction. However, since it is difficult to apply different corrections for each wireless terminal 20 in the time domain correction, the time domain correction may be performed based on the frequency offset correction value Δfₜᵢₘₑ and the timing offset correction value Δt^{time} common to all the wireless terminals 20.

In this case, the correction unit 12 may calculate the phase correction value θ^{time} for frequency offset compensation in the time domain by, for example, the following Formula (19).

$$\begin{matrix}[ Mathematical formula 19 ] & \\ {θ}^{t i m e} = 2 π \frac{Δ {f}^{time}}{K {f}_{0}} & ( 19 )\end{matrix}$$

Then, for example, the correction unit 12 may correct each transmission time domain sample sₗ[n] after the secondary modulation to the corrected transmission time domain sample s′ₗ[n] by the following Formula (20) with the sample index no as a reference.

$$\begin{matrix}[ Mathematical formula 20 ] & \\ {s}_{l}^{′} [ n ] = {s}_{l} [ n ] {e}^{- j {θ}^{t i m e} ( n - {n}_{0} )} & ( 20 )\end{matrix}$$

Furthermore, for example, in order to compensate for the timing offset in the time domain, the correction unit 12 may transmit the signal transmission timing shifted from the original transmission timing by Δt^{time}.

It is difficult to use different correction values for each wireless terminal 20 in the correction in the time domain. Therefore, for example, the correction unit 12 may use the same (uniform) correction value for all the wireless terminals 20. In this case, for example, the correction unit 12 may set the representative value (e.g. average value, mode, or median) averageᵢΔfᵢ of the assumed frequency offset of each of the plurality of wireless terminals 20 to be communicated in the target radio resource (e.g., every time frame) as the correction value Δf^{time} (=averageᵢΔfᵢ) of the frequency offset in the time domain. Furthermore, for example, the correction unit 12 may set the representative value averageᵢΔtᵢ of the assumed timing offset of each of the plurality of wireless terminals 20 to be communicated in the target radio resource as the correction value Δt^{time} (=averageᵢΔtᵢ) of the frequency offset in the time domain.

In addition, different corrections can be applied for each wireless terminal 20 in the correction in the frequency domain. Therefore, for example, the correction unit 12 may determine a difference between the assumed frequency offset Δfᵢ of each wireless terminal 20 and the correction value Δf^{time} of the frequency offset in the time domain as the correction value Δfᵢ^{freq} in the frequency domain for each wireless terminal 20 as in the following Formula (21).

$$\begin{matrix}[ Mathematical formula 21 ] & \\ Δ {f}_{i}^{freq} = Δ {f}_{i} - Δ {f}^{t i m e} & ( 21 )\end{matrix}$$

Furthermore, for example, the correction unit 12 may determine a difference between the assumed timing offset Δtᵢ of each wireless terminal 20 and the correction value Δt^{time} of the timing offset in the time domain as the Δtᵢ^{freq} correction value in the frequency domain for each wireless terminal 20 as in the following Formula (22).

$$\begin{matrix}[ Mathematical formula 22 ] & \\ Δ {t}^{freq} = Δ {t}_{i} - Δ {t}^{time} & ( 22 )\end{matrix}$$

### <Others>

The present disclosure relates to, for example, a base station device for compensating for at least one of a Doppler shift and a propagation delay accompanying movement of a wireless terminal in a wireless communication system that communicates with the wireless terminal moving at a high speed simultaneously with a plurality of base stations or while switching a plurality of base stations, for example. The present disclosure can be applied to, for example, a case where a plurality of base stations are connected to different control devices (e.g., a Central Unit (CU) and a Distributed Unit (DU)), a case where a plurality of base stations are connected to the same control apparatus and controlled, a case where a plurality of base stations have different physical cell IDs, a case where a plurality of base stations have the same cell ID, and the like.

In order to achieve a large capacity of a mobile communication system such as a cellular system, the importance of wireless communication using a high frequency band such as a millimeter wave or a terahertz wave capable of using a wideband frequency bandwidth has increased. In a case where a high frequency band is used for mobile communication, large-capacity communication is enabled as a wideband frequency bandwidth can be utilized, but there are the problem that a propagation loss dependent on a frequency is large, and the problem that an influence of a shielding object is large because straightness is high and a radio wave is less likely to go around.

As a means for solving the former propagation loss problem, there is a beamforming technology for enhancing a reception level of a radio signal transmitted in a direction in which a communication target exists by performing appropriate phase control on radio signals transmitted from a large number of antenna elements. It is possible to compensate for a large propagation loss due to a high frequency band by using the beamforming technology. Furthermore, as a means for solving the latter problem of straightness, there is a Distributed Antenna System (DAS). By extending the antenna of the base station and arranging the plurality of antennas in a distributed manner, a probability that line-of-sight communication between the antenna and the wireless terminal is interrupted is lowered.

In addition, in the conventional macro cell system, if the cell radius is large and the distance from the base station increases, the reception power of the wireless terminal located at the cell end decreases, and the wireless terminal strongly receives interference from the adjacent cell, and hence there is a problem that the communication quality deteriorates. As one of means for solving this problem, a technology for performing cooperative operation using a plurality of base stations (also referred to as an antenna/cell/Transmission Reception Point (TRP)/Access Point (AP) Etc.) installed at a relatively high density (e.g., Coordinated Multi-Point (COMP), Multi-TRP, Single Frequency Network (SFN), and distributed MIMO) has been put into practical use or has been studied.

Here, for example, in a case of an in-vehicle terminal in which a wireless terminal is mounted on a high-speed moving body such as a railway or an automobile to perform large-capacity communication, or in a wireless environment in which the wireless terminal moves at a high speed, movement of the wireless terminal between each of the communication areas of the plurality of base stations relatively increases, and thus, a Joint Transmission (JT) technology between the plurality of base stations and a Dynamic Point Selection (DPS) technology are particularly important.

On the other hand, if a plurality of base stations having different physical arrangements communicate with the wireless terminal, the wireless terminal is affected by different Doppler shifts and propagation delays for each base station. In a case where the Doppler shift and the propagation delay are greatly different for each base station, there is a possibility that the communication quality is degraded due to inter-subcarrier/inter-symbol interference in Orthogonal Frequency Division Multiplexing (OFDM), phase rotation in the frequency/time direction of the channel, and the like at the time of the operation of the JT and the DPS.

In the case of the DPS, in order to stabilize the communication quality upon switching the base station, it is necessary to compensate for a Doppler shift and a sudden change in a propagation delay. The same applies to the JT, and in the JT, a signal received by the wireless terminal from each of the base station antennas undergoes different Doppler shifts and propagation delays. It is difficult for the wireless terminal to simultaneously receive and compensate for different Doppler shifts and propagation delays of a plurality of base station antennas, and there is a possibility that the communication quality of JT is greatly reduced.

As a method of compensating a frequency offset caused by a Doppler shift and a timing offset caused by a propagation delay in advance (before transmission) in a base station that transmits a signal, there are “frequency domain pre-compensation” and “time domain pre-compensation”. In a wireless communication system, processing of converting a signal mapped in a frequency domain into a time domain by OFDM modulation or the like is often used at the time of signal modulation. The processing of applying correction to the signal in the frequency domain before modulation is “frequency domain pre-compensation”, and the processing of applying correction to the signal in the time domain after modulation is “time domain pre-compensation”.

Since the frequency domain pre-compensation is processing in a frequency domain in which a signal to be transmitted to each wireless terminal is mapped, different corrections can be applied for each wireless terminal. However, at the time of reception OFDM demodulation, it is impossible to compensate for inter-symbol interference and inter-subcarrier interference caused by the frequency offset and the timing offset.

The time-domain pre-compensation can compensate for including the influence of inter-symbol interference and inter-subcarrier interference. However, since the correction processing is performed on the time domain signal after the signals of the plurality of wireless terminals are combined by the OFDM modulation, it is difficult to perform different corrections for each wireless terminal in a case of simultaneously communicating with the plurality of wireless terminals.

On the other hand, according to the present disclosure, at least one of the propagation delay and the Doppler shift accompanying the movement of the wireless terminal can be more appropriately pre-compensated.

### Modified Example

Although the base station device 10 may be a device provided in one housing, the base station device 10 of the present disclosure is not limited thereto. Each unit of the base station device 10 may be implemented by, for example, cloud computing including one or more computers. Such a base station device 10 is also included in an example of the “base station device” of the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments can also be described as the following Supplementary Notes, but are not limited to the following. Some or all of the elements (e.g., configuration and function) described in each supplementary note dependent on supplementary note 1 can also be dependent on an independent supplementary note of another category in a similar dependency relationship. Some or all of the elements described in any supplementary note may be applied to various types of hardware, software, recording means for recording software, systems, and methods.

### (Supplementary Note 1)

A base station device including
an acquisition unit for acquiring information indicating a characteristic related to at least one of a propagation delay and a Doppler shift in each wireless terminal, and
a correction unit for correcting a phase of a signal to be transmitted to each wireless terminal in a frequency domain based on the characteristic in each wireless terminal.

### (Supplementary Note 2)

The base station device according to supplementary note 1, in which
the acquisition unit acquires information indicating a characteristic related to a propagation delay in each wireless terminal, and
the correction unit corrects a phase of a signal to be transmitted to each wireless terminal in a frequency domain based on a timing offset due to the propagation delay in each wireless terminal.

### (Supplementary Note 3)

The base station device according to supplementary note 1 or 2, in which
the acquisition unit acquires information indicating a characteristic related to a Doppler shift in each wireless terminal, and
the correction unit corrects a phase of a signal to be transmitted to each wireless terminal in a frequency domain based on a frequency offset due to a Doppler shift in each wireless terminal.

### (Supplementary Note 4)

The base station device according to supplementary note 1 or 2, in which the correction unit determines a correction value of a signal to be transmitted to each wireless terminal based on phase rotation between pilot signals transmitted from the base station device and received by each wireless terminal.

### (Supplementary Note 5)

The base station device according to supplementary note 1 or 2, in which the correction unit corrects a phase of a signal to be transmitted to each wireless terminal in a time domain and a frequency domain based on a characteristic in each wireless terminal.

### (Supplementary Note 6)

The base station device according to supplementary note 5, in which the correction unit corrects a phase of a signal to be transmitted to each wireless terminal in a time domain based on a representative value of a characteristic in each wireless terminal.

### (Supplementary Note 7)

The base station device according to supplementary note 6, in which the correction unit
corrects a phase of a signal to be transmitted to each wireless terminal in a time domain based on a representative value of a characteristic in each wireless terminal, and
corrects a phase of a signal to be transmitted to each wireless terminal in a frequency domain based on a difference between a characteristic value in each wireless terminal and the representative value.

### (Supplementary Note 8)

The base station device according to supplementary note 6, in which the correction unit corrects a phase of a signal to be transmitted to each wireless terminal in a time domain based on a representative value of a characteristic in each wireless terminal for each time frame.

### (Supplementary Note 9)

A communication method including
acquiring information indicating a characteristic related to at least one of a propagation delay and a Doppler shift in each wireless terminal, and
correcting a phase of a signal to be transmitted to each wireless terminal in a frequency domain based on the characteristic in each wireless terminal.

### (Supplementary Note 10)

A program for causing a computer to execute processing of
acquiring information indicating a characteristic related to at least one of a propagation delay and a Doppler shift in each wireless terminal, and
correcting a phase of a signal to be transmitted to each wireless terminal in a frequency domain based on the characteristic in each wireless terminal.

What is claimed is:

1. A base station device comprising:
a memory configured to store instructions; and
a processor configured to execute the instructions to:
acquire information indicating a characteristic related to at least one of a propagation delay and a Doppler shift in each wireless terminal; and
correct a phase of a signal to be transmitted to each wireless terminal in a frequency domain based on a characteristic in each wireless terminal.

2. The base station device according to claim 1, wherein the processor is further configured to execute the instructions to:
acquire information indicating a characteristic related to a propagation delay in each of the wireless terminals; and
correct a phase of a signal to be transmitted to each wireless terminal in a frequency domain based on a timing offset due to a propagation delay in each wireless terminal.

3. The base station device according to claim 1, wherein the processor is further configured to execute the instructions to:
acquire information indicating a characteristic related to a Doppler shift in each of the wireless terminals; and
correct a phase of a signal to be transmitted to each wireless terminal in a frequency domain based on a frequency offset due to a Doppler shift in each wireless terminal.

4. The base station device according to claim 1, wherein the processor is further configured to execute the instructions to:
determine a correction value of a signal to be transmitted to each wireless terminal based on phase rotation between pilot signals transmitted from the base station device and received by each wireless terminal.

5. The base station device according to claim 1, wherein the processor is further configured to execute the instructions to:
correct a phase of a signal to be transmitted to each wireless terminal in a time domain and a frequency domain based on a characteristic in each wireless terminal.

6. The base station device according to claim 5, wherein the processor is further configured to execute the instructions to:
correct a phase of a signal to be transmitted to each wireless terminal in a time domain based on a representative value of a characteristic in each wireless terminal.

7. The base station device according to claim 6, wherein the processor is further configured to execute the instructions to:
correct a phase of a signal to be transmitted to each wireless terminal in a time domain based on a representative value of a characteristic in each wireless terminal; and
correct a phase of a signal to be transmitted to each wireless terminal in a frequency domain based on a difference between a characteristic value in each wireless terminal and the representative value.

8. The base station device according to claim 6, wherein the processor is further configured to execute the instructions to:
correct a phase of a signal to be transmitted to each wireless terminal in a time domain based on a representative value of a characteristic in each wireless terminal for each time frame.

9. A communication method comprising:
acquiring information indicating a characteristic related to at least one of a propagation delay and a Doppler shift in each wireless terminal; and
correcting a phase of a signal to be transmitted to each wireless terminal in a frequency domain based on a characteristic in each wireless terminal.

10. A non-transitory computer-readable medium stored with a program for causing a computer to execute processing of
acquiring information indicating a characteristic related to at least one of a propagation delay and a Doppler shift in each wireless terminal; and
correcting a phase of a signal to be transmitted to each wireless terminal in a frequency domain based on the characteristic in each wireless terminal.
